(19) United States
(12) Patent Application Publication
(10) Pub. No.: US 2012/0291642 A1
(43) Pub. Date: Nov. 22, 2012

(54) METHODS, APPARATUS, AND SYSTEMS FOR DIRECT INKING TO A DIGITAL OFFSET PLATE

(75) Inventor: Augusto E. BARTON, Webster, NY (US)

(73) Assignee: XEROX CORPORATION, Norwalk, CT (US)

(21) Appl. No.: 13/108,490

(22) Filed: May 16, 2011

(51) Int. Cl. B41F 31/20

(52) U.S. Cl. 101/350.1

(57) ABSTRACT

A digital offset inking system includes an ink chamber that contains ink, and deposits ink onto an inking member. Excess deposited ink is removed from the surface of the inking member. The inking member transfers the ink directly to a conformable surface of an imaging member.

### FIELD OF DISCLOSURE

The disclosure relates to direct inking to a digital offset plate. In particular, the disclosure relates to ghostless inking systems for direct inking of, for example, an anilox roll to a digital offset plate.

### BACKGROUND

Inking systems are designed to transfer ink to offset plates. An inking system may be a keyed or key-less type. An inking system may be a regular offset-type printing system, or a digital offset plate printing system.

Related art inking systems can suffer from ghosting issues. In inking systems, transferred ink may be deposited in a layer. The layer may have areas of varying thickness. Ghosting can result from an ink layer being thinner in a particular area where an image has been previously transferred. Areas of thinner ink in ink layers typically cause corresponding lighter areas in image prints.

In related art systems, and particularly in, e.g., regular offset systems, ghosting issues may be addressed by using inker rolls that each have about the same diameter. Such an arrangement causes a repeating image to always be on the same location on the rolls, and circumvents the effects of ghosting.

### SUMMARY

For digital offset, however, a key-less inker having reduced ghosting issues is desirable. An inking system that is effective in reducing ghosting issues is provided. For example, methods, apparatus, and systems accommodate inking directly from an anilox roll to a digital offset plate with reduced occurrence of ghosting. An embodiment of methods may include depositing ink from an ink chamber onto an inking member. The inking member may include ink wells for containing inking deposited from an ink chamber. Methods may include leveling the ink on the inking member. The ink may be leveled by applying a doctor blade to a surface of the inking member. The doctor blade may be configured to remove excess ink from the inking member surface, and/or an ink well of the inking member.

An embodiment of methods includes transferring the deposited ink directly to a conformable digital offset member, e.g., plate. Another embodiment may include removing fountain solution transferred from the conformable digital offset plate to the inking member. The fountain solution may be removed by e.g., a doctor blade or an air knife, or a combination of removal mechanisms including at least an air knife and/or a doctor blade.

An embodiment of a digital offset inking system may include an ink chamber, an inking member, and an ink chamber doctor blade configured to remove excess ink from the inking member. The ink chamber may be configured to deposit the ink on a surface of the inking member. In an embodiment of systems, the inking member may be configured to include one or more wells for holding ink deposited by the ink chamber. The inking member may be, for example, an anilox roll. The ink wells may be one of a tri-helical or quad-channel type arranged about a surface of the roll. In alternative embodiments, the wells may be configured to have any shape that is suitable for carrying ink from an inking chamber to an offset surface for transfer thereto.

In an embodiment of systems, an imaging member includes a conformable offset surface. The inking member may be configured to contact the imaging member. For example, the inking member may be a rotatable member configured to bring ink deposited from an ink chamber into contact with the imaging member. The ink deposited from the ink chamber, and in embodiments, leveled to remove excess ink, may be transferred from the inking member directly to the conformable offset surface.

During transfer, fountain solution from the imaging member may be transferred to a surface of the inking member. In an embodiment of systems, a fountain solution system may be configured to remove the fountain solution from the surface of the inking member. In an embodiment, the fountain solution removal system may be a doctor blade. In another embodiment, the fountain solution removal system may be an air knife. In yet another alternative embodiment, the fountain solution removal system may be a combination of a doctor blade and an air knife. At least one of the doctor blade and the air knife may be configured to remove fountain solution from a surface of the inking member.

In another embodiment of systems, a digital offset inking system may include an inking chamber for depositing ink. The inking system may include an inking member for carrying ink deposited by the ink chamber. The inking member may including a doctor blade for removing excess ink, e.g., leveling the ink deposited from the ink chamber. In another embodiment, the inking chamber may include a chamber blade for containing the ink in the ink chamber, e.g., in combination with a portion of the inking member and/or a doctor blade.

In an embodiment, the digital offset inking system may include an imaging member for receiving ink transferred from the inking member. The imaging member may include a conformable surface, e.g., the imaging member may be a conformable offset plate. A fountain solution on a surface of the imaging member may be transferred to the inking member during transfer of a ink or an ink layer from the inking member to the imaging member. The inking system may include a fountain solution removal system configured to remove fountain solution from the inking member, e.g., after ink transfer.

Exemplary embodiments are described herein. It is envisioned, however, that any system that incorporates features of apparatus and systems described herein are encompassed by the scope and spirit of the exemplary embodiments.

### BRIEF DESCRIPTION OF THE DRAWINGS

FIG. 1 shows a digital offset architecture;

FIG. 2 shows an inking system with a fountain solution doctor blade in accordance with an exemplary embodiment;

FIG. 3 shows an inking system with an air knife in accordance with an exemplary embodiment;

FIG. 4A shows an imaging member well structure in accordance with an exemplary embodiment;

FIG. 4B shows an imaging member well structure in accordance with an exemplary embodiment;

FIG. 5 shows a graph depicting results of an anilox roll and rubber transfer roll ink transient test;

FIG. 6 shows a graph depicting results of an anilox roll ink transient test.

### DETAILED DESCRIPTION

Exemplary embodiments are intended to cover all alternatives, modifications, and equivalents as may be included within the spirit and scope of the apparatus and systems as described herein.

Reference is made to the drawings to accommodate understanding of methods, apparatus, and systems for direct inking to a digital offset plate. In the drawings, like reference numerals are used throughout to designate similar or identical elements. The drawings depict various embodiments and data related to embodiments of illustrative methods, apparatus, and systems for inking directly from an inking member to an imaging member.

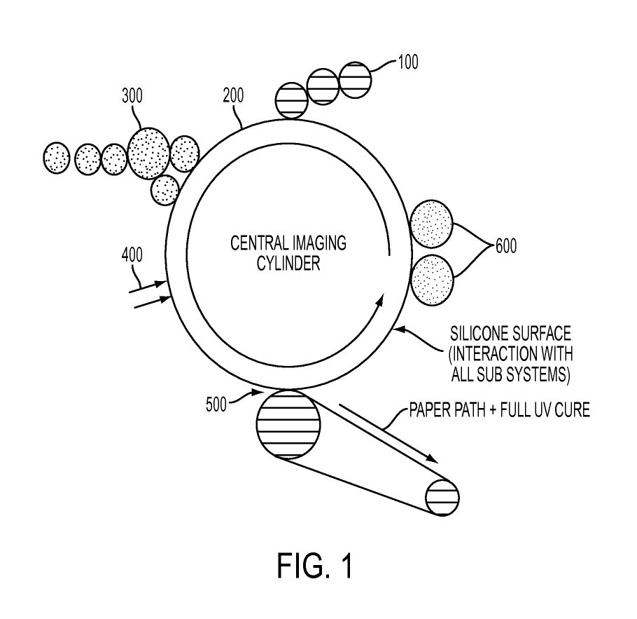

Methods, apparatus, and systems of embodiments are preferably key-less and accommodate ghostless inking directly to a digital offset plate. FIG. 1 shows a digital offset architecture that may be included in systems of embodiments. Specifically, FIG. 1 shows a central imaging cylinder and a paper path architecture that together form a media transfer nip. FIG. 1 shows the steps of a digital offset that occur about the central imaging cylinder. For example, a uniform application of fountain solution may be applied to a surface of the central imaging cylinder by a dampening system in a fountain solution application step 100. In a digital evaporation step 200, particular portions of the fountain solution layer applied to the surface of the central imaging cylinder may be evaporated by a digital evaporation system. For example, portions of the fountain solution layer may be evaporated by laser patterning using, for example, a Texas Instruments DLP projector chip.

In an inking step 300, ink may be transferred from an inking member to the surface of the central imaging cylinder. The transferred ink adheres to portions of the surface of the central imaging cylinder where a fountain solution has been evaporated. In a partial cure step 400, the transferred ink may be partially cured by irradiation, for example, UV cure. In an image transfer step 500, the transferred ink may be transferred to media such as paper at a media transfer nip.

In a step 600, a surface of the central imaging cylinder may be cleaned by a cleaning system. For example, trace cleaning rollers may be used to clean the surface of the central imaging cylinder. In embodiments, the surface of the central imaging cylinder is conformable. The surface of the central imaging cylinder may be made of, for example, silicone.

Ink may be transferred to a central imaging cylinder, as shown in inking step 300 of FIG. 1, from an inking member of an inking system. An inking member may be, for example, an anilox roll having wells or cells for containing ink to be transferred to the imaging member. The wells may be mechanically or laser engraved, and may be configured to contain a volume of ink. Inking systems of embodiments include a system for removing excess ink from one or more cells. For example, ink may be deposited onto an inking member by an ink chamber so that ink fills and overflows one or more wells of the inking member. In accordance with methods of embodiments, the one or more wells may be leveled to remove excess ink from a surface of the inking member, e.g., by removing the ink overflow using a doctor blade.

For example, the ink chamber may be associated with a doctor blade or similar suitable structure. The doctor blade may be configured to doctor excess ink deposited in a cell of the inking member from the surface of the inking member. A chamber blade may be associated with the ink chamber. The chamber blade and the doctor blade may be configured to contain ink within the chamber. For example, the chamber blade, inking member, and doctor blade, in combination, may be configured to contain ink inside the ink chamber. Ink containment may be further facilitated by seals such as side seals.

The inking member, which may be an anilox roll, for example, may be configured to translate rotatably about a central longitudinal axis. Ink may be deposited by the ink chamber into one or more cells of an inking member when the inking member is at a first position. The inking member may be rotated to a second position at which the deposited ink is transferred directly to an imaging member, e.g., a digital offset transfer plate. The imaging member may be a central imaging cylinder, such as that diagrammatically shown in FIG. 1, and ink may be transferred to the imaging member directly from an inking system in an inking step 300.

During transfer of the deposited ink from the inking member to the imaging member, fountain solution from the surface of the inking member may be transferred to the inking member. In embodiments, the inking member may then be rotated to a third position at which the fountain solution may be removed from a surface of the inking member. A fountain solution removal system may be configured to remove fountain solution. For example, a fountain solution removal system may include a doctor blade that is configured to remove fountain solution. In an alternative embodiment, the fountain solution removal system may include an air knife that is configured to evaporate fountain solution from a surface of the inking member.

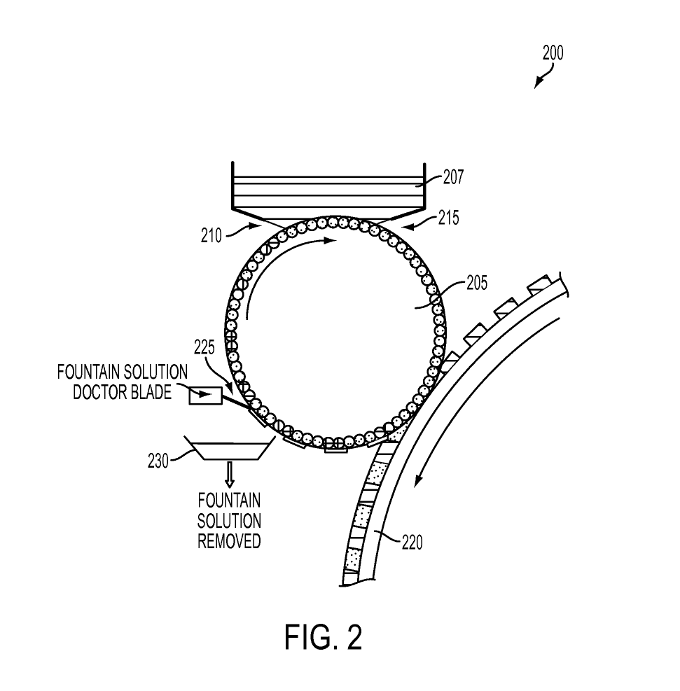

In another alternative embodiment, the fountain solution removal system may include a combination of at least a fountain solution doctor blade and an air knife for removing fountain solution transferred from the imaging member to the inking member. FIG. 2 shows an exemplary inking system that accommodates ghostless inking. Specifically, FIG. 2 shows a direct inking digital offset system 200. The digital offset system 200 includes an inking system having an inking member 205. An ink chamber 207 may be positioned adjacent to the inking member 205. The ink chamber 207 may be configured to deposit ink into one or more wells of the inking member 205.

For example, the inking member 205 may include a surface having one or more wells or cells configured to hold ink deposited by the ink chamber 207. The cells may be structured to have a tri-helical shape, or a quad-channel shape, or similarly structured for preferably permitting smoother solids and better ink fluidity and transfer for high viscosity inks, e.g., about 400,000 cps. Such high viscosity inks are a typical selection for digital offset applications. The cells may be mechanically or laser-engraved.

The ink chamber 207 may be associated with a chamber blade 210 and a doctor blade 215. The chamber blade 210 may be configured to contain ink within the ink chamber 207. Ink containment may be enhanced with the combination of doctor blade 215 and chamber blade 210. FIG. 2 shows the chamber blade 210 and the doctor blade 215 being configured and arranged to contain the ink in the ink chamber 207. The inking member 205 may also be positioned to facilitate containment of the ink within ink chamber 207 as shown in FIG. 2. Ink may be deposited by the ink chamber 207 in one or more cells of the inking member 205. The deposited ink may be transferred to a surface of an imaging member 220. For example, the inking member 205 may be rotatable from an ink deposit position, to an ink transfer position. Fountain solution located on a surface of the imaging member 220 may be transferred to the inking member 205 during transfer of the deposited ink from the inking member 205 to the imaging member 220.

The fountain solution transferred to the inking member 205 may be removed by a fountain solution removal system. For example, the inking member 205 may be rotatable from an ink transfer position to a fountain solution removal position as shown in FIG. 2. The fountain solution removal system may include a doctor blade 225 and a fountain solution containment system 230. The doctor blade may be configured to remove fountain solution from the inking member 205.

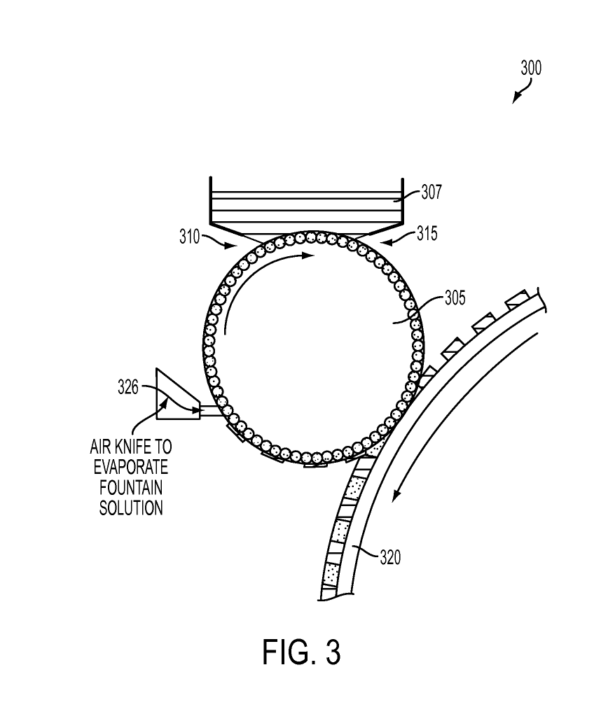

In another embodiment, the fountain solution removal system may include a combination of at least a fountain solution doctor blade and an air knife for removing fountain solution transferred from the imaging member to the inking member. FIG. 3 shows an exemplary inking system that accommodates ghostless inking. Specifically, FIG. 3 shows a direct inking digital offset system 300. The digital offset system 300 includes an inking system having an inking member 305. An ink chamber 307 may be positioned adjacent to the inking member 305. The ink chamber 307 may be configured to deposit ink into one or more wells of the inking member 305.

For example, the inking member 305 may include a surface having one or more wells or cells configured to hold ink deposited by the ink chamber 307. The cells may be structured to have a tri-helical shape, or a quad-channel shape, or similarly structured for preferably permitting smoother solids and better ink fluidity and transfer for high viscosity inks, e.g., about 400,000 cps. Such high viscosity inks are a typical selection for digital offset applications. The cells may be mechanically or laser-engraved.

The ink chamber 307 may be associated with a chamber blade 310 and a doctor blade 315. The chamber blade 310 may be configured to contain ink within the ink chamber 307. Ink containment may be enhanced with the combination of doctor blade 315 and chamber blade 310. FIG. 3 shows the chamber blade 310 and the doctor blade 315 being configured and arranged to contain the ink in the ink chamber 307. The inking member 305 may also be positioned to facilitate containment of the ink within ink chamber 307 as shown in FIG. 3. Ink may be deposited by the ink chamber 307 in one or more cells of the inking member 305. The deposited ink may be transferred to a surface of an imaging member 320. For example, the inking member 305 may be rotatable from an ink deposit position, to an ink transfer position. Fountain solution on a surface of the imaging member 320 may be transferred to the inking member 305 during transfer of the deposited ink from the inking member 305 to the imaging member 320.

The fountain solution transferred to the inking member 305 may be removed by a fountain solution removal system. For example, the inking member 305 may be rotatable from an ink transfer position to a fountain solution removal position as shown in FIG. 3. The fountain solution removal system may include a doctor blade 325. The doctor blade may be configured to remove fountain solution from the inking member 305.

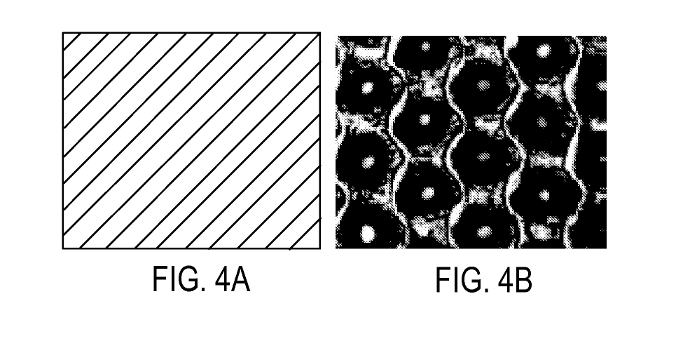

As discussed above, the inking member may be an anilox roll, for example. The ink used in the inking system may be a high viscosity ink. For example, the ink may have a viscosity on the order of 400,000 cps. To facilitate inks of this viscosity and similar viscosities, the anilox roll may be configured to include a surface that defines cells having high-viscosity ink-accommodating patterns. For example, FIG. 4A shows a cell pattern having a tri-helical structure. FIG. 4B shows a different cell pattern; in particular FIG. 4B shows a cell pattern structured to have a quad-channel arrangement. These cell types and others permit smoother solids and better ink fluidity, and improved transfer for high viscosity inks. Accordingly, such cell pattern structures may be particularly suitable for inks typically used in digital offset processes.

It has been found that ghosting is significantly reduced when direct inking from an inking member such as an anilox roll to a digital offset plate where the surface of the digital offset plate is conformable. Traditional key-less inking systems, which may include an anilox roll followed by a conformable transfer roll typically suffer from ghosting. Transient tests show that there is an ink thickness transient that occurs in an ink transfer roll. Tests show that it takes about three to four revolutions of an ink transfer roll for the transient to arrive at a steady-state ink thickness.

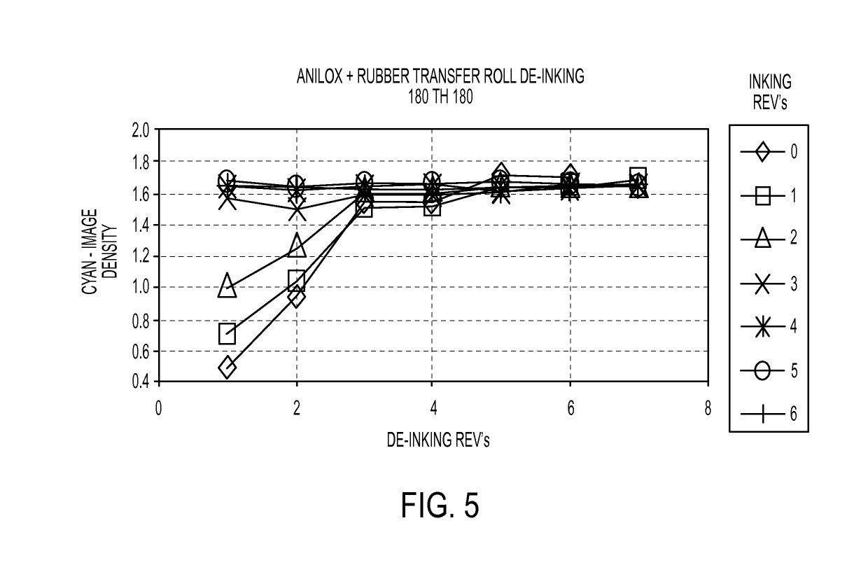

For example, FIG. 5 shows a graph depicting results of an anilox roll and rubber transfer roll ink transient test. Indeed, as shown in FIG. 5, it may take as many as three to four revolutions of an ink transfer roll for the transient to arrive at a steady-state ink thickness.

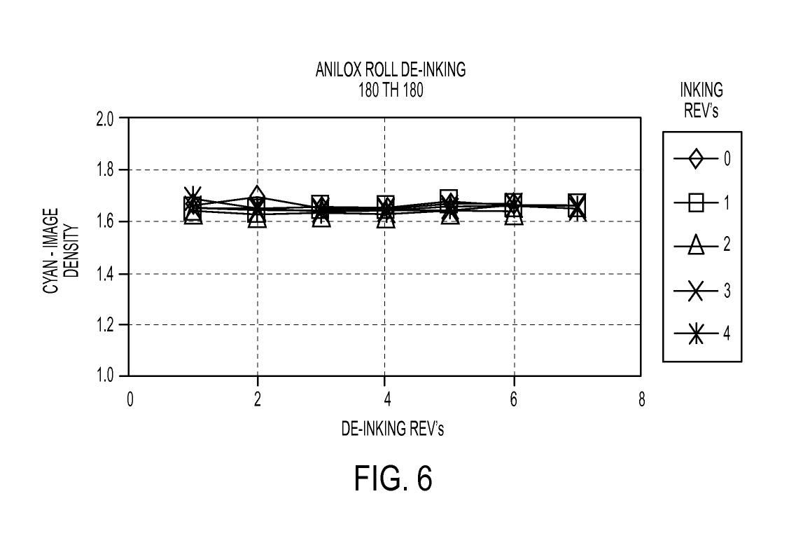

FIG. 6 shows a graph depicting results of an anilox roll ink transient test. In systems having only an anilox roll inking directly to a digital offset plate or imaging member, there is no observed ink thickness transient. Accordingly, systems in accordance with embodiments achieve reduced ghosting among other reductions in undesirable effects by inking directly from an inking member to a digital offset plate or surface. In particular, systems, apparatus, and methods of embodiments include inking directly to a digital offset surface that is conformable. Further, systems of embodiments include an ink chamber and means for removing excess ink deposited in cells an inking member, prior to ink transfer. Further, systems in accordance with the embodiments may include removing fountain solution from the surface of the inking member using a fountain solution removal system having, for example, at least one of a doctor blade and an air knife, as discussed above.

While apparatus and systems for digital offset inking are described in relationship to exemplary embodiments, many alternatives, modifications, and variations would be apparent to those skilled in the art. Accordingly, embodiments of apparatus and systems as set forth herein are intended to be illustrative, not limiting. There are changes that may be made without departing from the spirit and scope of the exemplary embodiments.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. A digital offset inking method, comprising:
removing excess ink from an inking member; and
transferring ink directly from the inking member to a conformable digital offset plate.

2. The method of claim 1, further comprising:
removing fountain solution from the inking member.

3. The method of claim 2, the removing fountain solution comprising applying a doctor blade to a surface of the inking member.

4. The method of claim 2, the removing fountain solution comprising applying an air knife to a surface of the inking member.

5. The method of claim 1, further comprising:
removing fountain solution from the inking member using at least one of a doctor blade and an air knife.

6. The method of claim 1, the transferring ink directly from the inking member to the digital offset plate being after removing excess ink from a surface of the inking member.

7. The method of claim 1, the leveling comprising doctoring excess ink from a surface of the ink roll.

8. A digital offset inking system, comprising:
an ink chamber;
an inking member, the inking member having an ink well that receives ink from the ink chamber;
an ink chamber doctor blade configured to remove excess ink from the ink well.

9. The digital offset inking system of claim 8, further comprising:
an imaging member, the imaging member having a conformable offset surface.

10. The digital offset inking system of claim 8, the inking member further comprising:
a plurality of ink wells, wherein the plurality of ink wells are arranged in one of a tri-helical pattern or a quad-channel pattern.

11. The digital offset inking system of claim 8, wherein the inking member directly contacts an imaging member to transfer ink carried by the inking member.

12. The digital offset inking system of claim 9, further comprising:
a fountain solution removal system for removing fountain solution transferred from the imaging member to the inking member.

13. The digital offset inking system of claim 12, the fountain solution removal system comprising at least one of an air knife and a doctor blade.

14. The digital offset inking system of claim 8, the imaging member comprising an anilox roll.

15. A digital offset inking apparatus, comprising:
an ink chamber, the ink chamber defining an ink outlet; and
at least one of a chamber blade and a doctor the blade, the chamber blade being configured to extend from the ink chamber to an inking member surface, and the doctor blade being configured to extend from the ink chamber to an inking member surface.

16. The digital offset inking apparatus of claim 15, further comprising:
an inking member, the inking member being configured to receive ink from the ink outlet defined by the ink chamber, the doctor blade being configured to remove excess ink from a surface of the inking member.

17. The digital offset inking apparatus of claim 15, further comprising:
a fountain solution removal system, the fountain solution removal system being configured to remove fountain solution from a surface of the inking member.

18. The digital offset inking apparatus of claim 17, the fountain solution removal system comprising an air knife.

19. The digital offset inking apparatus of claim 17, the fountain solution removal system comprising a doctor blade.

20. An digital offset inking system, comprising:
an ink chamber for depositing ink;
an inking member for directly transferring ink deposited by the ink chamber to an imaging member, the ink chamber including a doctor blade for removing excess ink deposited by the ink chamber before the transferring ink; and
a fountain solution removal system for removing fountain solution from the inking member after the directly transferring ink from the inking member to the imaging member.
